(19) United States
(12) Patent Application Publication
(10) Pub. No.: US 2003/0090738 A1
(43) Pub. Date: May 15, 2003

(54) Channel estimation in a facsimile modem and method therefor

(76) Inventors: Satish Ananthaiyer, Mansfield, MA (US); Eric David Elias, Plainville, MA (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 10/054,248

(22) Filed: Nov. 13, 2001

(51) Int. Cl. H04N 1/00

(52) U.S. Cl. 358/405; 358/407

(57) ABSTRACT

A facsimile modem transmitter (40) uses pre-fax control signals, such as an answer tone or an FSK (frequency shift keying) modulation signal, to determine a channel spectral shape of the transmission media (14) before transmitting the fax data. The transmitter (40) determines average energy values of the pre-fax signals as a function of frequencies to determine the channel spectral shape. Using the channel spectral shape information, an appropriate transmission shaping filter (64, 66, 68) is chosen for use by the transmitter (40). This achieves better transmit and receive performance by compensating for roll-off on the transmission media (14), or channel, without the need to use specific training signals.

### FIELD OF THE INVENTION

The present invention relates generally to facsimile (fax) transmissions, and more particularly, to channel estimation in a fax modem transmitter.

### BACKGROUND OF THE INVENTION

In a fax transmission over a landline telephone system, if roll-off of the channel, or transmission media, is significant, fax transmission speeds can be very slow. Channel roll-off is a decrease in signal power as signal frequency increases. A cause for the slow transmission speeds in this case can be the result of a poor signal-to-noise ratio (SNR) in the fax receiver. That is, if the fax receiver equalizer is designed properly for the particular characteristics of the channel, including roll-off, then amplification in the equalizer of the fax receiver will cause noise from the channel to be enhanced. The fax receiver will then cause the transmission rate to be reduced. In some cases, a connection may not be made at all because of the poor quality of the channel.

Therefore, a need exists for a fax transmission system that compensates for channel roll-off to improve fax transmission quality and speed.

### BRIEF DESCRIPTION OF THE DRAWINGS

FIG. 1 illustrates, in block diagram form, a fax transmission system in accordance with the present invention.

FIG. 2 illustrates a method for channel estimation in a fax modem transmitter in accordance with the present invention.

FIG. 3 illustrates, in block diagram form, a fax modem transmitter in accordance with a first embodiment of the present invention.

FIG. 4 illustrates, in block diagram form, a fax modem transmitter in accordance with a second embodiment of the present invention.

### DETAILED DESCRIPTION

Generally, the present invention provides a facsimile modem transmitter that uses a received control signal, such as for example, an answer tone and FSK (frequency shift keying) modulation signal, that was sent to the transmitter at the beginning of a fax data transmission from a fax terminal receiving the fax data, to determine a channel spectral shape of the transmission media. Using the channel spectral shape information, an appropriate transmission shaping filter is chosen for use by the transmitter. This achieves better transmit and receive performance by compensating for roll-off on the transmission media, or channel, without the need to use specific training signals.

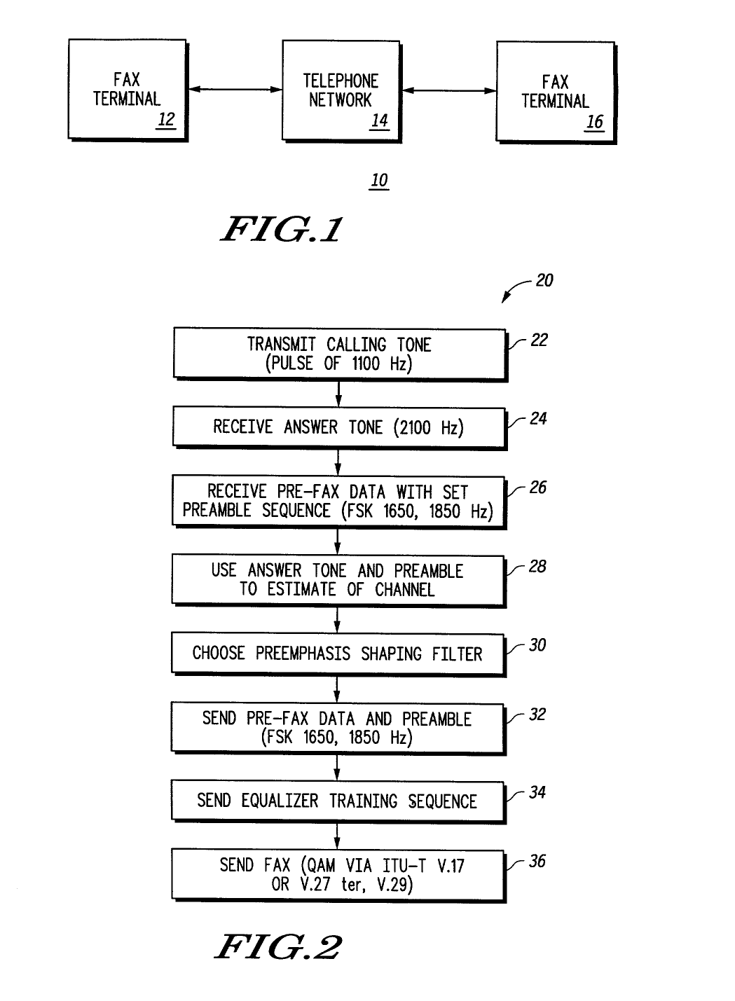

FIG. 1 illustrates, in block diagram form, a fax transmission system 10 in accordance with the present invention. To send a fax, fax transmission system 10 includes two fax terminals connected by a channel, or transmission media, such as for example, a conventional telephone network using two-wire twisted pair telephone lines.

To initiate a fax transmission in a system as illustrated in FIG. 1, a fax modem transmitter in fax terminal 12, for example, may transmit a calling tone over the telephone network 14 to a fax receiver in fax terminal 16. The receiving fax terminal will transmit an answer tone and other pre-fax setup and training information depending on the particular fax standard being used. Different pre-fax information is mandated by ITU-T fax recommendations depending on data transmit/receive speeds. Examples of various appropriate fax standards are EIA/TIA-578, ITU T.30, ITU V.27ter, ITU V.29, ITU V.17, and ITU V.34. The fax terminals, as used by the present invention, may be any kind of fax device operating in accordance with one of the various fax standards and implemented in hardware, software, or a combination of hardware and software, such as for example, conventional fax machines or personal computers equipped for sending and receiving fax transmissions.

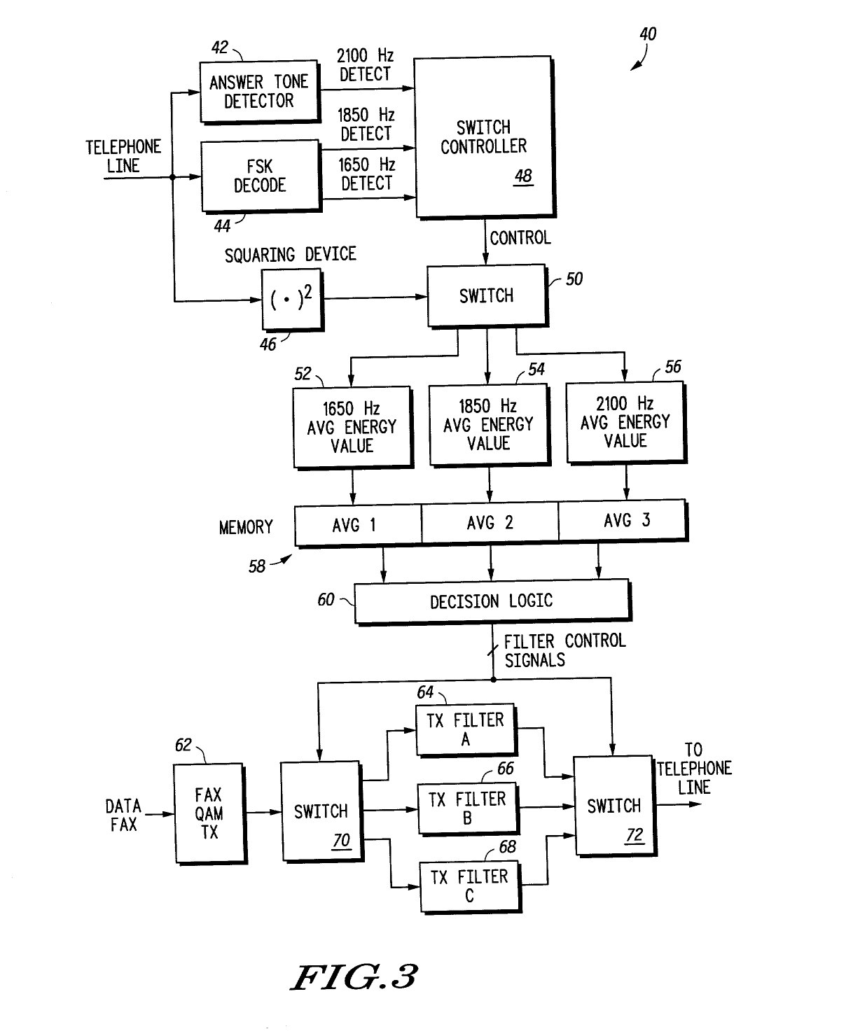

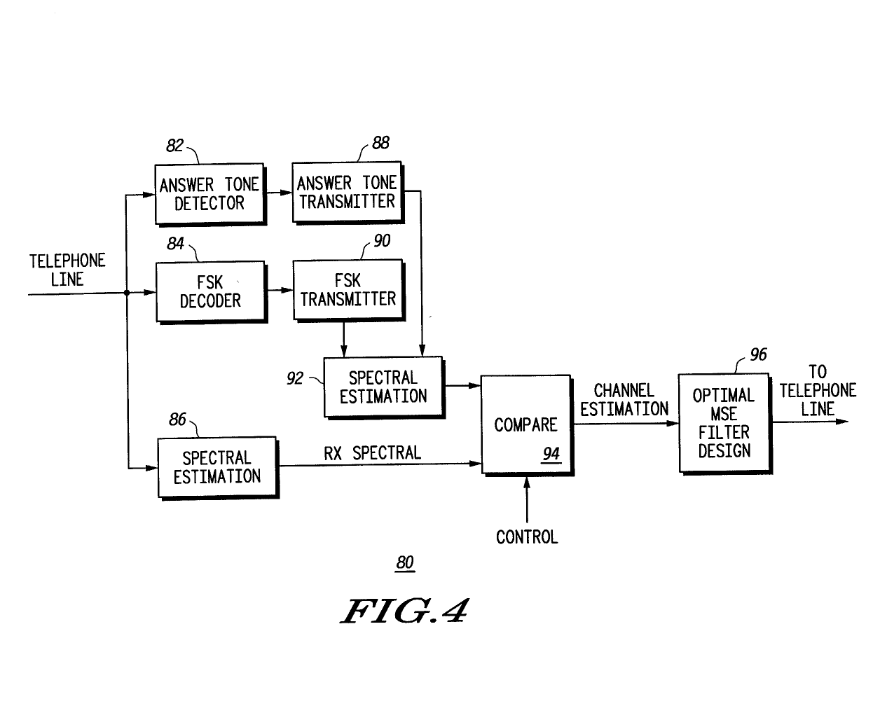

In accordance with one embodiment of the present invention, the fax terminal 12 uses the answer tone (optional) and FSK signals (from V.21 standard) to estimate a spectral shape, including roll-off, of the channel. The fax terminal 12 then uses the spectral shape estimate to determine an appropriate transmit shaping filter. The apparatus and method for determining an appropriate shaping filter will be discussed in more detail in the discussion of FIGS. 3 and 4. The fax data is then transmitted over the telephone network 14 via the appropriate shaping filter to the fax terminal 16. The fax receiver of fax terminal 16 may include adaptive equalizer circuitry (not shown) to provide further improvement to fax quality and transmission speed.

FIG. 2 illustrates a method 20 for channel estimation in a fax modem transmitter in accordance with the present invention. In the illustrated embodiment, the facsimile modem transmitter is implemented as sets of instructions stored via computer readable media. At step 22, to initiate a fax transmission, a fax modem transmitter at the sending end may transmit a calling tone in accordance with one of the fax standards. The calling tone may be a 1100 hertz (Hz) pulse. In response to the call, at step 24, a receiving fax terminal will transmit an answer tone (2100 Hz), and at step 26 the receiving fax terminal will receive other pre-fax information required by the particular standard for configuring the sending and receiving fax terminals (V.21 FSK 1650 Hz and 1850 Hz in the illustrated embodiment). At step 28, the fax transmitter at the sending end uses the answer tone and FSK information to estimate the spectral shape of the channel. Typically, the spectral shape will indicate a roll-off of the signal strength with increasing frequency. In the illustrated embodiment, the channel is a two-wire twisted pair used in a conventional landline telephone network. In other embodiments, the telephone network may comprise a 4-wire twisted pair, a microwave link, satellite link, fiber-optic network, or the like. At step 30, the channel estimate can be used by the fax transmitter to choose from one of several preprogrammed preemphasis shaping filters, or the channel estimate can be used to design a preemphasis shaping filter for the fax transmitter. The shaping filter that is chosen will be used to compensate for the roll-off of the channel as determined by the channel estimate. This will improve the signal received by the fax receiver, thus allowing for faster transmission speed and thus increased data throughput.

At step 32, the fax transmitter sends pre-fax data and preamble information. For example, in the illustrated embodiment, an FSK of 1650 and 1850 Hz is transmitted. At step 34, an equalizer training sequence is provided to the fax receiver. The equalizer training sequence is used to facilitate convergence of the fax receiver equalizer, providing better receiver performance. At step 36, the fax transmitter sends the fax data. The fax data can be from one of many sources. For example, one source of fax data is a scanned hardcopy of the information to be transmitted. Another source of fax data can be a computer-generated image displayed on a computer screen. The fax data can be transmitted using one of the many existing fax standards such as QAM via, ITU-T V.17, ITU V.27ter, or ITU V.29.

FIG. 3 illustrates, in block diagram form, a fax modem transmitter in accordance with a first embodiment of the present invention. In the illustrated embodiment, a fax transmitter 40 is implemented in software as a part of a software fax modem in a personal computer (not shown). Note that even though the present embodiment is in the form of a software fax modem, those skilled in the art of fax modems will recognize that the fax transmitter 40 can also be implemented in hardware or a combination of hardware and software.

The fax transmitter 40 includes answer tone detector 42, FSK decoder 44, squaring device 46, switch controller 48, switch 50, average energy values 52, 54, and 56, accumulators 58, decision logic 60, fax quadrature amplitude modulation (QAM) transmitter 62, switches 70 and 72, and transmit shaping filters 64, 66, and 68.

Answer tone detector 42 has an input coupled to the telephone line (channel) for receiving fax data and control signals, and has an output for providing a detect signal labeled “2100 Hz DETECT”. FSK decoder 44 has an input coupled to the channel, and a first output for providing a detect signal labeled “1850 Hz DETECT”, and a second output for providing a detect signal labeled “1650 Hz DETECT”. Squaring device 46 has an input coupled to the channel, and an output. Switch controller 48 has inputs for receiving the detect signals from the answer tone detector 42 and the FSK decoder 44, and an output terminal for providing a control signal labeled “CONTROL” to a control input of switch 50. Switch 50 also has three output terminals for providing a power value to accumulators 52, 54, and 56 depending on control signal CONTROL.

A first output terminal of switch 50 is coupled to an input of average energy value 52, a second output terminal of switch 50 is coupled to an input of average energy value 54, and a third output of switch 50 is coupled to an input of average energy value 56. An output of average energy value 52 is to coupled to an input of accumulators 58 for storing an average energy value of the 1650 Hz FSK decode signal. An output of average energy value 54 is coupled to an input of accumulators 58 for storing an average energy value of the 1850 Hz FSK decode signal. An output of average energy value 56 is coupled to an input of memory 58 for storing an average energy value of the 2100 Hz answer tone. Output terminals of accumulators 58 is coupled to input terminals of decision logic 60. Output terminals of decision logic 60 are coupled to control switches 70 and 72. Fax QAM transmitter 62 has an input for receiving the data to be transmitted or the telephone line, and an output terminal coupled to an input terminal of switch 70. Switch 70 has a plurality of output terminals, each of the output terminals is coupled to an input of one of transmit shaping filter 64, 66, and 68. Note that in the illustrated embodiment, three shaping filters are shown. However, in other embodiments, any number of shaping filters may be included. An output terminal of each of shaping filters 64, 66, and 68 is coupled to corresponding input terminals of switch 72. An output terminal of switch 72 is coupled to the telephone line, or channel.

In operation, after transmitting the calling tone to a receiving fax terminal, fax transmitter 40 will receive pre-fax signals from the receiving fax terminal. The pre-fax signals may include an answer tone, which is received by answer tone detector 42, and an FSK signal, which is received by FSK decoder 44. In addition, the pre-fax signals are received by squaring device 46. Squaring device 46 is used to determine the average power of the pre-fax signals when the pre-fax signals are detected and a corresponding detect signal is used to route the pre-fax signal passing through squaring device 46 to the produce one of the average energy values 52, 54, and 56. For example, in response to receiving the answer tone, answer tone detector 42 will send a 2100 hertz detect signal to switch controller 48. In response to the receiving the FSK signals, the FSK decoder will send an 1850 Hz detect signal and a 1650 Hz detect signal to switch controller 48. The switch controller 48 controls the loading of the average power values 52, 54, and 56, generated by the squaring device 46, to the appropriate locations in accumulators 58. Decision logic 60 receives the average power values 52, 54, and 56, and in response, provides control signals labeled “FILTER CONTROL SIGNALS” to switches 70 and 72. The average power values 52, 54, and 56 are used to determine the channel estimate. Using the channel estimate, the appropriate preemphasis shaping filter can be selected or calculated. Also, in another embodiment implemented in software, the average signal power of the FSK signal may be used to calculate filter coefficients for a preemphasis shaping filter corresponding to the channel estimate. Also, the filter coefficients may be obtained from a lookup table based on the channel estimation. In response to the FILTER CONTROL SIGNALS, switches 70 and 72 insert an appropriate one of the transmit shaping filters 64, 66, and 68 into the data path of the fax data transmitted onto the telephone line. Note that in the illustrated embodiment, switches are used to connect a shaping filter to the transmit path, however, in other embodiments, other circuits such as multiplexers or decoders may be used.

In the illustrated embodiment, the answer tone and FSK signals are used to determine a spectral shape, or roll-off, of the channel. The average powers of the answer tone and FSK signals are used to determine an estimate, or slope, of the roll-off for the channel. When the slope of the roll-off is known, a shaping filter is chosen to compensate for the roll-off. This improves the quality of the transmitted fax data, thus allowing the data to be transmitted at higher data rates.

FIG. 4 illustrates, in block diagram form, a fax modem transmitter in accordance with a second embodiment of the present invention. Fax transmitter 80 includes answer tone detector 82, FSK decoder 84, spectral estimation 86, answer tone transmitter 88, FSK transmitter 90, spectral estimation 92, compare circuit 94, and optimal MSE (mean square error) filter design.

Answer tone detector 82, FSK decoder 84, and spectral estimation block 86 each have an input coupled to a telephone line. An output of answer tone detector 82 is coupled to an input of answer tone transmitter 88. An output of FSK decoder 84 is coupled to an input of FSK transmitter 90. An output of each of answer tone transmitter 88 and FSK transmitter 90 are coupled to inputs of spectral estimation block 92. An output of each of spectral estimation blocks 86 and 92 are coupled to inputs of compare circuit 94. An output of compare circuit 94 provides a channel estimation labeled “CHANNEL ESTIMATION” to an input of optimal MSE filter design block 96. An output of optimal MSE filter design block 96 is coupled to the telephone line.

In operation, during the beginning of a fax transmission, and after transmitting the calling tone (optional), the fax transmitter 40 will receive pre-fax signals from a receiving fax terminal. The pre-fax signals may include an answer tone, which is received by the answer tone detector 82, and an FSK signal, which is received by the FSK decoder 84. In addition, the pre-fax signals are received by the spectral estimation block 86. Answer tone detector 82, when present, will provide a detect signal to the answer tone transmitter 88. In response, answer tone transmitter 88 will provide a pre-channel answer tone, that is, an answer tone that has not been modified by the channel to an input of spectral estimation block 92. Likewise, FSK decoder 84 will provide a detect signal to the FSK transmitter 90 when an FSK signal is received. In response, FSK transmitter 90 will provide an FSK signal that has not been modified by the channel to an input of spectral estimation block 92. Spectral estimation block 92 provides a pre-channel spectral estimation to an input of compare circuit 94. The pre-channel spectral characteristics do not include modifications that would be introduced by the channel after pre-fax signals are transmitted from the receiving fax terminal.

As illustrated, spectral estimation block 86 receives the pre-fax signals as modified by the channel, and provides a post-channel spectral estimation to an input of compare circuit 94. The post-channel spectral characteristics are estimated over a continuous time period at a plurality of different frequencies, and include modifications introduced by the channel after transmission from a receiving fax terminal. In response to receiving a control signal labeled “CONTROL”, the compare circuit 94 provides the channel estimation to an input of optimal MSE filter design 96. Optimal MSE filter design 96 can be used to either select filter coefficients from a look table to be used in a predetermined shaping filter, or to design a filter based on additional criteria. The filter designed, or generated, by Optimal MSE filter design 96 is then inserted into the data path of the fax data from a fax QAM transmitter.

What is claimed is:

1. A method for transmitting facsimile data over a channel, comprising:
receiving a frequency shift keying (FSK) signal;
using the FSK signal to estimate the channel to obtain a channel estimation;
determining a preemphasis shaping filter based on the channel estimation;
applying the preemphasis shaping filter to the facsimile data to produce filtered facsimile data; and
transmitting the filtered facsimile data over the channel.

2. The method of claim 1, wherein the step of using the FSK signal to estimate the channel comprises:
determining an average signal power of the FSK signal.

3. The method of claim 2, wherein determining the preemphasis shaping filter comprises:
using the average signal power of the FSK signal to select a preemphasis shaping filter corresponding to the channel.

4. The method of claim 2, wherein the step of determining the preemphasis shaping filter comprises:
using the average signal power of the FSK signal to calculate coefficients for the preemphasis shaping filter corresponding to the channel.

5. The method of claim 1, further comprising receiving an answer tone and wherein using the FSK signal to estimate the channel comprises using the answer tone and the FSK signal to estimate the channel to obtain the channel estimation.

6. The method of claim 5, wherein using the answer tone and the FSK signal to estimate the channel comprises:
determining an average signal power for each one of answer tone and the FSK signals.

7. The method of claim 6, wherein determining the preemphasis shaping filter comprises using the average signal power for each one of the answer tone and the FSK signal to select or calculate a preemphasis shaping filter corresponding to the channel.

8. The method of claim 5, wherein using the answer tone and the FSK signal to estimate the channel comprises:
using the answer tone and FSK signal to estimate post-channel spectral characteristics of the answer tone and FSK signal;
using the answer tone and FSK signal to estimate pre-channel spectral characteristics of the answer tone and FSK signal; and
comparing the pre-channel spectral characteristics with the post-channel spectral characteristics to obtain the channel estimation.

9. The method of claim 1, wherein using the FSK signal to estimate the channel comprises:
using the FSK signal to estimate post-channel spectral characteristics of the FSK signal;
using the FSK signal to estimate pre-channel spectral characteristics of the FSK signal; and
comparing the pre-channel spectral characteristics with the post-channel spectral characteristics to obtain the channel estimation.

10. The method of claim 9, wherein the post-channel spectral characteristics are estimated over a continuous time period at a plurality of different frequencies.

11. The method of claim 9, wherein:
the post-channel spectral characteristics include modifications introduced by the channel after transmission from a receiver terminal, wherein the receiver terminal receives the facsimile data transmission, and
the pre-channel spectral characteristics do not include modifications introduced by the channel after transmission from the receiver terminal.

12. The method of claim 9, wherein determining the preemphasis shaping filter comprises:
calculating coefficients of the preemphasis shaping filter based on the channel estimation.

13. The method of claim 9, wherein determining the preemphasis shaping filter comprises:
obtaining coefficients of the preemphasis shaping filter from a lookup table based on the channel estimation.

14. A facsimile modem transmitter which transmits facsimile data over a channel, comprising:
a frequency shift keying (FSK) detector having an input coupled to the channel which receives FSK signals;
a pre-channel spectral unit coupled to the FSK detector, and having an output which provides a pre-channel spectral estimation of the FSK signals;
a post-channel spectral unit having an input coupled to the channel which receives FSK signals, and an output which provides a post-channel spectral estimation of the FSK signals;
a compare unit having a first input which receives the pre-channel spectral estimation and a second input which receives the post-channel spectral estimation, and an output which provides a channel estimation based at least in part on a comparison of the pre-channel spectral estimation and the post-channel spectral estimation; and
a filter generating unit having an input which receives the channel estimation and an output which provides coefficients corresponding to a preemphasis shaping filter.

15. The facsimile modem transmitter of claim 14, wherein:
the FSK detector comprises an FSK decoder having an input which receives the FSK signals, and
the pre-channel spectral unit further comprises:
an FSK transmitter coupled to the FSK decoder, and
an estimator coupled to the FSK transmitter for estimating the pre-channel spectral estimation of the FSK signals.

16. The facsimile modem transmitter of claim 15, further comprising:
an answer tone detector having an input coupled to the channel which receives an answer tone; and
wherein the pre-channel spectral unit is coupled to the answer tone detector and the output of the pre-channel spectral unit provides a post-channel spectral estimation of the answer tone and FSK signals.

17. The facsimile modem transmitter of claim 15, wherein the facsimile modem transmitter comprises a software facsimile modem transmitter, the software facsimile modem transmitter comprising the FSK detector, the pre-channel spectral unit, the post-channel spectral unit, the compare unit, and the filter generating unit.

18. A facsimile modem transmitter which transmits facsimile data over a channel, comprising:
a frequency shift keying (FSK) detector having an input coupled to the channel which receives FSK signals and having a first output which provides a control signal;
an average signal power unit having a first input coupled to the channel and a second input which receives the control signal, and an output which selectively provides an average signal power at each FSK signal frequency based on the control signal; and
a filter generating unit having inputs which receive the average signal power at each FSK signal frequency and an output which provides coefficients corresponding to a preemphasis shaping filter.

19. The facsimile modem transmitter of claim 18, wherein the FSK detector further comprises:
an answer tone detector having an input coupled to the channel which receives an answer tone, wherein the control signal is based on the FSK signals and the answer tone; and
wherein the average signal power unit selectively provides an average signal at an answer tone frequency based on the control signal, the answer tone frequency corresponding to the answer tone.

20. The facsimile modem transmitter of claim 18, wherein the facsimile modem transmitter comprises a software facsimile modem transmitter, the software facsimile modem transmitter comprising the FSK detector, the average signal power unit, and the filter generating unit.

21. In a facsimile modem transmitter, a method for transmitting facsimile data from a facsimile modem over a channel, comprising:
receiving a plurality of signals from a receiver terminal, wherein the receiver terminal is for receiving the facsimile from the facsimile modem transmitter;
in response to receiving the plurality of signals, the facsimile transmitter using the plurality of signals to estimate the channel to obtain a channel estimation;
determining a preemphasis shaping filter based on the channel estimation;
applying the preemphasis shaping filter to the facsimile data; and
transmitting the filtered facsimile data to the receiver terminal.

22. The method of claim 21, wherein the plurality of signals are used for other purposes outside of channel estimation.

23. The method of claim 22, wherein the plurality of signals do not include coefficients corresponding to the preemphasis shaping filter.

24. The method of claim 21, wherein:
portions of the plurality of signals are modified by the channel after being transmitted by the receiver terminal, and
using the plurality of signals to estimate the channel comprises using the modified portions of the plurality of signals to obtain the channel estimation.

25. A facsimile modem transmitter for transmitting facsimile data over a channel stored via computer readable media, comprising:
a first set of instructions for receiving frequency shift keying (FSK) signals;
a second set of instructions for using the FSK signals to estimate the channel to obtain a channel estimation;
a third set of instructions for determining a preemphasis shaping filter based on the channel estimation;
a fourth set of instructions for applying the preemphasis shaping filter to the facsimile data; and
a fifth set of instructions for transmitting the filtered facsimile data.

26. The facsimile modem transmitter of claim 25, further comprising:
a sixth set of instructions for determining an average signal power for each one of the FSK signals; and
a seventh set of instructions for using the average signal power for each one of the FSK signals to select or calculate a preemphasis shaping filter corresponding to the channel.

27. The facsimile modem transmitter of claim 25, further comprising a sixth set of instructions for receiving an answer tone, and the second set of instructions comprises a seventh set of instructions for using the answer tone and the FSK signals to estimate the channel to obtain the channel estimation.

28. The facsimile modem transmitter of claim 25, further comprising:
a sixth set of instructions for using the FSK signals to estimate post-channel spectral characteristics of the FSK signals;
a seventh set of instructions for using the FSK signals to estimate pre-channel spectral characteristics of the FSK signals; and
an eighth set of instructions for comparing the pre-channel spectral characteristics with the post-channel spectral characteristics to obtain the channel estimation.

29. A facsimile modem transmitter for transmitting facsimile data over a channel stored via computer readable media, comprising:
a first set of instructions for receiving a plurality of signals from a receiver terminal, wherein the receiver terminal receives the facsimile data transmission;
a second set of instructions for using the plurality of signals, in response to receiving the plurality of signals, to estimate the channel to obtain a channel estimation;
a third set of instructions for determining a preemphasis shaping filter based on the channel estimation;
a fourth set of instructions for applying the preemphasis shaping filter to the facsimile data; and
a fifth set of instructions for transmitting the filtered facsimile data to the receiver terminal.

30. The facsimile modem transmitter of claim 29, wherein:
portions of the plurality of signals are modified by the channel after being transmitted by the receiver terminal, and
the second set of instructions comprises a sixth set of instructions for using the modified portions of the plurality of signals to obtain the channel estimation.
